(19) United States
(12) Patent Application Publication
(10) Pub. No.: US 2004/0202992 A1
(43) Pub. Date: Oct. 14, 2004

(54) Electronic test answer record quality assurance system and method

(76) Inventors: Scott Moulthrop, Converse, TX (US); Lois L. Barth, San Antonio, TX (US); Daniel L. Pena, San Antonio, TX (US)

Correspondence Address: ALLEN, DYER, DOPPELT, MILBRATH & GILCHRIST, PA, P.O. BOX 3791, ORLANDO, FL, 32802-3791, US

(21) Appl. No.: 10/412,863

(22) Filed: Apr. 14, 2003

(51) Int. Cl. G09B 3/00; G09B 7/00

(52) U.S. Cl. 434/353

(57) ABSTRACT

A system, method, and software application performs a record-checking and -correcting procedure that is substantially contemporaneous with a test answer page scanning process. The accuracy of an electronic record containing data from the answer page is thereby improved. The method includes receiving a record containing digital image scan data on an answer page. Next the record is checked for a plurality of types of errors. If one or more errors are found, a predetermined list of automatically correctable errors is consulted. Any found errors that are the list are automatically corrected. If any of the found errors is not on the list, the record is flagged for manual correction.

### BACKGROUND OF THE INVENTION

1. Field of the Invention

The present invention relates to systems and methods for scanning, imaging, and storing test answer sheet data, and, more particularly, to automated systems and methods for processing and correcting errors in records containing scanned test answer sheet images and data.

2. Description of Related Art

The automation of test scoring is a complex problem that has brought to bear significant economic pressure to optimize efficiency and accuracy and to minimize human involvement. Optimal mark reading (OMR) systems are well known in the art, such as those for scanning forms containing data such as bar codes or pencil marks within preprinted areas such as ovals. OMR systems can sense data recorded within the preprinted areas by detecting light absorbed in the near infrared, which is referred to as NIR scanning. This method permits the differentiation of pencil marks from preprinted information, which is provided in a pigment that does not absorb in the NIR. OMR systems permit a gathering of data that are easily converted into digital form, saved in electronic records, and ultimately scored against an answer database.

The scanning and data collection from test answer sheets by visual imaging means is also known in the art, for example, in commonly owned U.S. Pat. Nos. 6,173,154, 6,311,040, and 6,366,760, the disclosures of which are incorporated hereinto by reference. These patents teach a combination of OMR and visual imaging for capturing a full visual image of each answer page containing an answer to an open-ended question.

When large numbers of tests are to be graded at a scoring center, typically groups of physical test booklets are retained together based upon a particular criterion, such as individual grade levels from a particular school or school district, and a predetermined number are placed on a cart. Each test booklet is separated into individual answer sheets, and the cart is moved to a scanning area. The individual answer sheets are then sent through a scanner, which creates a scanner output record for each test booklet. The record contains such data as identifier information and test answer data gleaned from the answer sheets.

The complete system includes integrated hardware elements and software applications for capturing optical mark and full visual images of an answer page, for storing the images, for retrieving the images, for distributing the visual images to a reader for scoring, for assisting the reader in scoring, and for monitoring the reader's performance.

The scanning system comprises means for sequentially advancing each page of a plurality of answer pages along a predetermined path. Positioned along the path are mark imaging means (OMR, optical mark recognition; OCR, optical character recognition) for capturing a location of an optical mark on each answer page and visual imaging means for capturing a full visual image of each answer page. A forms database in a server is provided that contains data on the physical location and type (e.g., multiple-choice or open-ended) of each answer on each page. Software means resident in the server operate with the forms database to determine whether the captured image contains an answer to an open-ended question. If such an open-ended answer is supposed to be found on the page being imaged, the full visual image of the page is stored.

In the past, an error in the scanner output record might go undetected until a time after the cart of physical test booklets has been removed from the scanning area, at which point the related test booklet may need to be located from a storage area and either rescanned or the electronic record manually corrected, a labor-intensive process that can disturb scoring work flow. Therefore, it is desirable to implement an automated system and method for detecting errors in the electronic record, preferably prior to the cart's having been moved out of the scanning area. It is also desirable to implement such a system and method that can correct at least some of the detected errors.

### SUMMARY OF THE INVENTION

The present invention comprises a system containing a computer software application and a method to address the above-stated need for a record-checking and -correcting procedure that is substantially contemporaneous with the scanning process. The system and method are for improving the accuracy of an electronic record containing data from an answer page of a test booklet.

The method of the present invention comprises the step of receiving a record containing digital image scan data on an answer page. Next the record is checked for a plurality of types of errors. If one or more errors are found, a predetermined list of automatically correctable errors is consulted. Any found errors that are on the list are automatically corrected. If any of the found errors is not on the list, the record is flagged for manual correction.

The software application of the present invention comprises code segments for performing the method steps outlined above.

The system of the present invention comprises a storage device containing a plurality of records, each record containing digital image scan data on an answer page. The system also comprises a processor in signal communication with the storage device and a software application resident on the processor as outlined above.

This system software application, and method have been found beneficial, since many errors can be corrected automatically, and those that are not corrected can be flagged for manual correction before the physical answer page is removed from the scanning area. Obviously this system and method saves human labor when errors are automatically corrected, and considerable time once scoring has begun, since scoring workflow on a set of records containing the answer page with an error must be halted if an error is detected.

### BRIEF DESCRIPTION OF THE DRAWINGS

FIG. 1 is a schematic of a hardware configuration of a preferred embodiment of the complete scanning system.

FIG. 2 illustrates an exemplary header page.

FIG. 3 is a schematic of image data flow through the scanning system.

FIG. 4 is a flowchart for the software application.

FIGS. 5A-5C is a more detailed flowchart of the error-checking and -correcting portion of the software application.

### DETAILED DESCRIPTION OF THE PREFERRED EMBODIMENTS

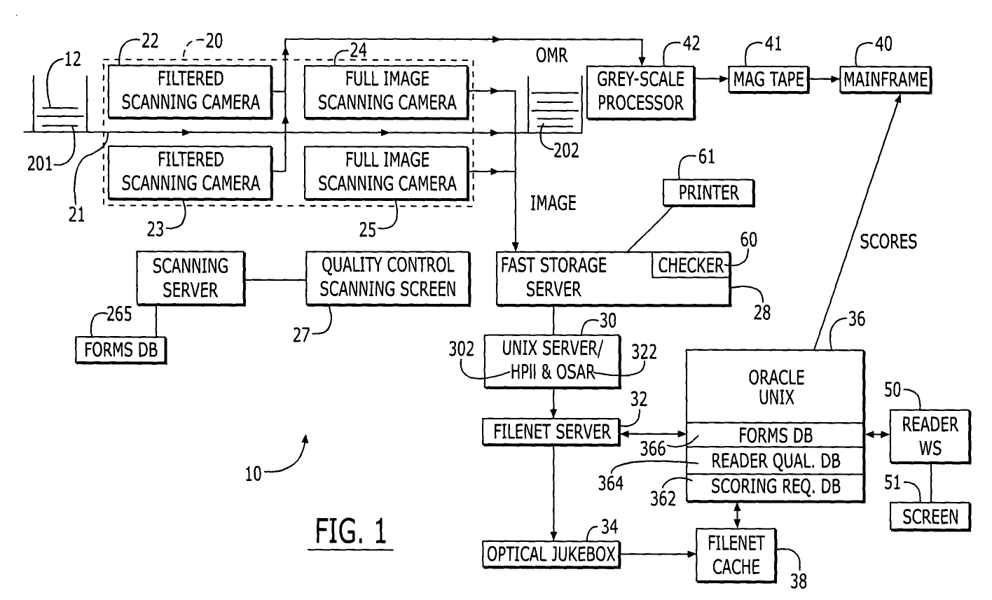

A description of the preferred embodiments of the present invention will now be presented with reference to FIGS. 1-5C.

The Image Capturing, Record Checking, and Storage Hardware System

A schematic of a hardware configuration of a preferred embodiment of the present invention is illustrated in FIG. 1, which includes the imaging and image storing elements. The imaging and scoring system 10 hardware elements include a scanner 20 for imaging answer pages. A preferred embodiment of the scanner 20 comprises a modified Scan-Optics 9000 unit, rated for 120 pages/min.

Standardized tests are typically given in batches to students belonging to a particular group, for example, a plurality of sixth-grade students from different schools and different classrooms in a particular geographical region. Each unique test document is assigned a document, or form, identifier, when it is produced. This number is reserved during the process of creating the test.

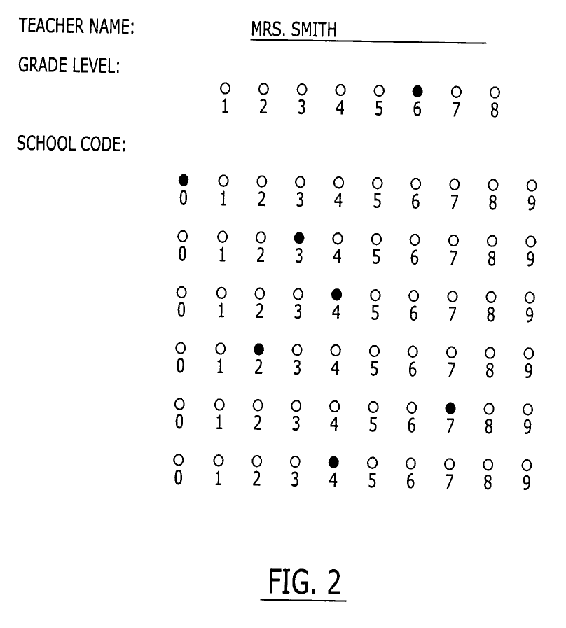

Each student receives a coded booklet comprising a plurality of pages, and, following test administration, all the test booklets are delivered to a scoring center for processing. An order header page 13 (FIG. 2) provides alphanumeric character and OMR-readable data for tracking the booklets. Order header page 13 includes, for example, such information as teacher name 131 (“Mrs. Smith”), grade level 133 (“6”), and school code 132 (134274), the latter two having an associated “bubble” filled in for each number. This configuration is exemplary and is not intended as a limitation. One or more of such batches may together form an “order,” and an order number is also assigned to track this (e.g., all Grade 6 classes in Greenwich, Conn.).

Another document, the UID, is also filled out by the teacher or test administrator. This document codes associated data for an order number. The UID typically contains data such as school name, number of students, student classifications, etc.

Each test booklet is entered, for example, via bar code, for later demographic correlation with scores, and is cut apart into individual, usually two-sided pages.

An exemplary embodiment of a method for delivering pages between areas includes making a plurality of stacks of pages on a cart. The cart and each stack are assigned, respectively, a cart number and a stack number. The first stack on a cart begins with a stack header page, an order header page, the UID, and then student documents. Each subsequent stack on that cart begins with a stack header page.

In some instances, barcodes may be present. If present, the barcode scans as a number that uniquely correlates with an existing student record.

The test booklet pages are removed from their cart and are stacked sequentially into an entrance hopper 201 of a scanner 20 by an operator, who has a unique identifier associated with him/her. Each page 12 is fed by methods well known in the art onto a belt 21 for advancing the page 12 along a predetermined path. The belt 21 has a substantially transparent portion for permitting the page 12 to be imaged on both sides simultaneously by two sets of cameras.

A first set of cameras includes an upper 22 and a lower 23 camera, each filtered for infrared wavelengths. This set 22,23 is for optical mark recognition (OMR), used to detect the location of pencil marks, for example, filled-in bubbles such as are common in multiple-choice answers, on both sides of the page 12. Alternatively, OCR marks are detected and processed.

The OMR scan data are greyscale processed by means 42 known in the art for detection of corrections and erasures. The data are then routed to a long-term storage device, such as magnetic tape 41, for later scoring and further processing in a mainframe computer 40.

A second set of cameras includes an upper 24 and a lower 25 camera, each substantially unfiltered. This set 24,25 is for capturing a full visual image of both sides of the page 12. A type of camera useful for this step comprises, but is not intended to be limited to, an infrared reflective image camera. Mark density and location data are gleaned from this scan as well.

The page 12 continues along the path on the belt 21 and is collected in sequence with previously scanned pages in an exit hopper 202.

The scanner 20 is under the control of a first server 26, such as a Novell server, which performs a plurality of quality-control functions interspersed with the imaging functions. Software means resident on the first server 26 determine that each page being scanned is in sequence from preprinted marks on the page indicating page number. If it is not, the operator must correct the sequence before being allowed to continue scanning.

The first server 26 additionally has software means resident thereon for determining, by consulting a forms database 265, whether the page being scanned contains an answer to an open-ended question. If it does, a full visual image of the page is made.

The first server 26 also has software means resident thereon for determining whether the page 12 is scannable. Pages containing OMR data contain timing tracks as are known in the art for orienting the page with respect to optical mark position. A page that has these missing is not scannable, and a substitute page marked “unscannable” in placed into the document indicating to the reader that a request for a hard copy must be made before this page can be scored.

A visual page image that is to be saved is stored temporarily in a second server, comprising a fast storage server 28 having a processor that has a response time sufficiently fast to keep pace with the visual image scanning step. Such a second server 28 may comprise, for example, a Novell 4.x, 32-Mb RAM processor with a 3-Gb disk capacity.

Following the storing of images on the fast storage server, and prior to removing the cart from which a respective batch of images has been stored, each image is subjected to a software application 60 resident on the fast storage server 28 that checks for a plurality of error types. As will be described in the following section, errors that can be automatically corrected are corrected; records for those that are not correctable are flagged for manual correction. Locators for lagged records are sent to an output device, such as a printer 61, for an operator to address manually.

The checked data are transferred at predetermined intervals to a third server 30 having software means 302 resident therein for performing a high-performance image indexing (HPII) on the visual image. This is for processing the data for optical storage and retrieval (OSAR). Third server 30 may comprise, for example, a UNIX 256-Mb RAM processor with a 10-Gb disk capacity having 3.2.1 FileNet and custom OSAR software resident thereon.

The answer images are finally transferred to a long-term storage unit 34 for later retrieval. Such a unit 34 may comprise, for example, one or more optical jukeboxes, each comprising one or more optical platters. Preferably two copies are written, each copy to a different platter, for data backup.

Next the transaction log data are transferred to a fourth server 32. Fourth server 32 may comprise, for example, a UNIX 64-Mb RAM processor having Oracle and FileNet software resident thereon.

The Error Checking and Correction Software Application

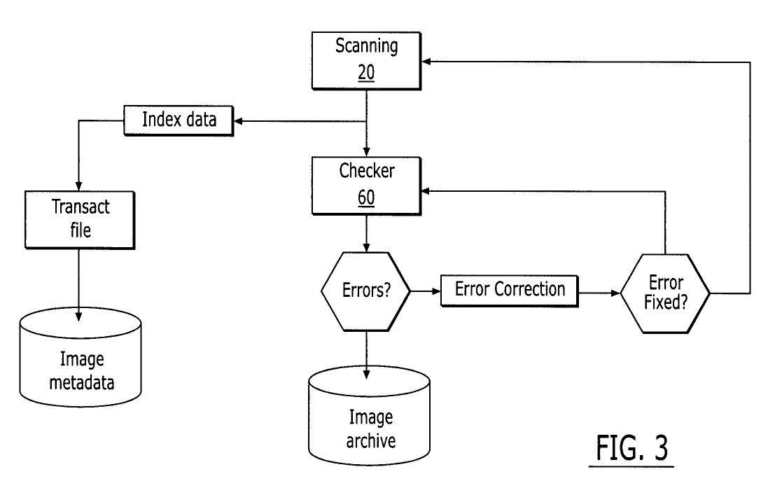

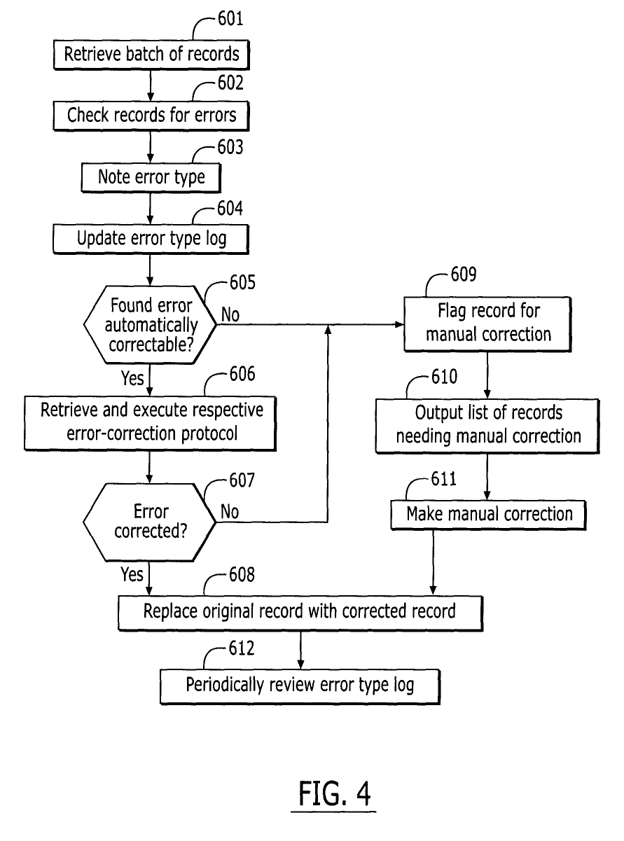

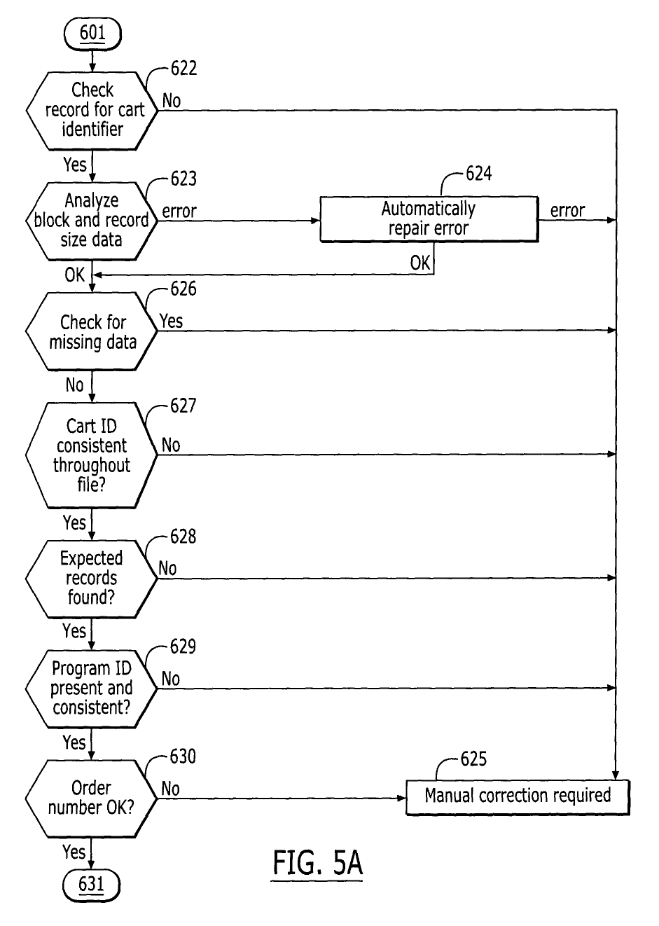

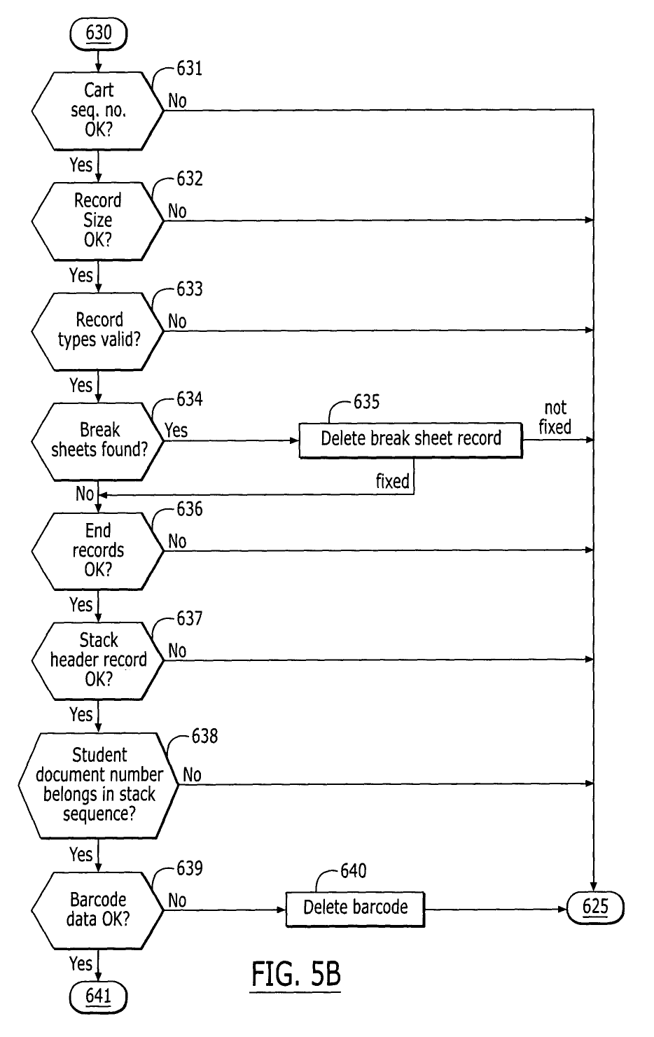

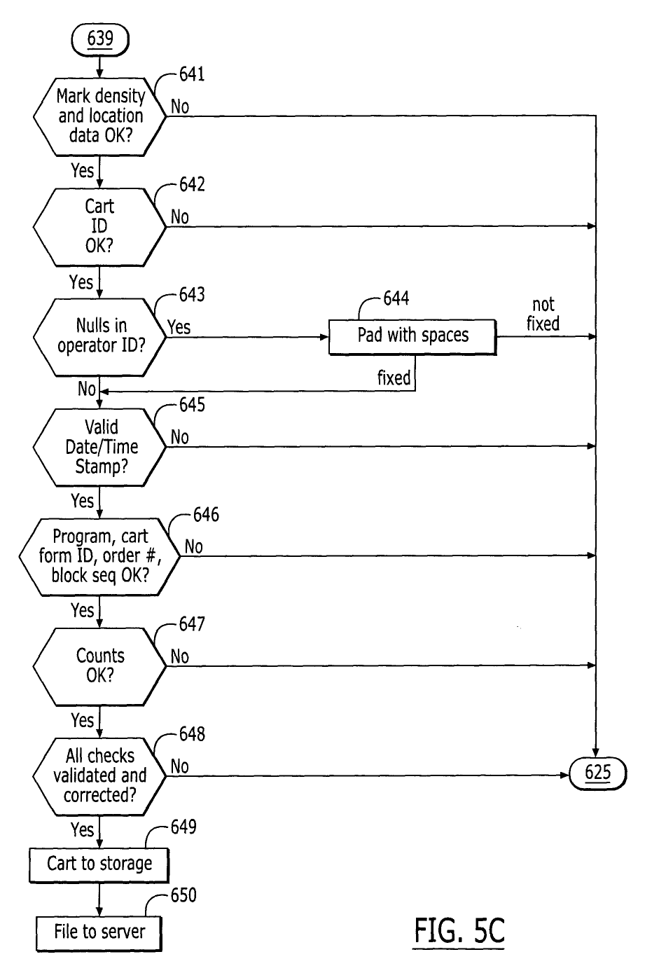

A data flow diagram to and from the software application 60 is given in FIG. 3; a flowchart, in FIG. 4. FIGS. 5A-5xx is a more detailed flowchart of the error-checking and -correcting portion of FIG. 4.

The software application 60 first retrieves from the fast storage server 28 a batch of records that has been sent from the scanner 20 (block 601, FIG. 4). The records include digital image scan data on an answer page 12. The digital scan image data include, for example, metadata relating to the record, image density, and a mark location. Other data include, but are not intended to be limited to, block size, record size, record length, operator identifier, tape identifier, cart identifier, order number, student number, barcode data, scan date and time.

The software application 60 then checks the batch of records sequentially for a plurality of errors (block 602). For each error found, the application 60 notes the error type (block 603), and updates an error type log (block 604). Each found error is then compared with a list of automatically correctable errors stored in the server 28 (block 605). For each error that is automatically correctable, a respective error-correction protocol linked to the predetermined list of correctable errors is retrieved and executed (block 606). Next a determination is made as to whether the error has been corrected (block 607). If the error has been corrected, the corrected record is stored in place of the original record (block 608). If the error has not been corrected, the record is flagged for manual correction (block 607).

For each error that is not automatically correctable (block 605), the record is also flagged for manual correction (block 609). A list of records requiring manual intervention is then output (block 610), a manual correction is made (block 611), and the corrected record is stored in place of the original record (block 608).

At predetermined intervals, the error type log is reviewed in order to enable improvement on a source of a persistent error (block 612).

With reference to FIGS. 5A-5C, a more detailed view of an exemplary embodiment of the error-checking and -correcting portion of the software application 60, illustrating a sequential checking and correction as possible of each error type checked.

When a batch of records arrives as a file from the scanner 20 to the server 28, the software application 60 retrieves the records (block 601). Each record is checked for cart identifier (block 622), and then the block and record size data are analyzed (block 623). The block sizes are validated by comparing them with each other and locating the cart identifier. If an error is found, the block size, record size, and record length can be automatically repaired (block 624). If not fixed, manual correction is required (block 625).

A check is made for missing data (block 626) by using the cart identifier as a delimiter. If an error remains, manual correction is required (block 625). A check is made that the cart identifier is consistent throughout the file (block 627). If not, manual correction is required (block 625).

The beginning of the file is then checked for four expected records: begin record, cart stack, order header, and UID (block 628). These errors are not automatically correctable, and thus manual correction is required (block 625).

It is then verified that the program identifier exists in the database 36, and that the program identifier is consistent throughout the file (block 629). These errors are not automatically correctable, and thus manual correction is required (block 625).

It is then verified that the order number is valid and is assigned to the current program identifier, by comparing these data within the database 36 tables (block 630). These errors are not automatically correctable, and thus manual correction is required (block 625).

Next the cart sequence number is checked, that is, that the current cart sequence number is greater than the preceding cart sequence number (block 631). This error is not automatically correctable, and thus manual correction is required (block 625).

Record size is then checked for falling within a predetermined range (block 632). These errors are not automatically correctable, and thus manual correction is required (block 625).

Valid record types are then checked (block 633). This error is not automatically correctable, and thus manual correction is required (block 625).

Break sheets are then searched for (block 634). If found, the record pertaining thereto is deleted (block 635). If this is not accomplished properly, manual correction is required (block 625).

Missing or multiple end records are then searched for (block 636). This error is not automatically correctable, and thus manual correction is required (block 625).

The stack header record is then checked for sequence with the preceding stack header (block 637). This error is not automatically correctable, and thus manual correction is required (block 625).

The student document number is checked to ensure that it belongs in the current stack sequence (block 638). This is accomplished by checking the student document sequence number against the last stack header document processed. This error is not automatically correctable, and thus manual correction is required (block 625).

The barcode type and values are checked for validity, as being within a predetermined size range (block 639). The application 60 will delete the barcode (block 640) if it is invalid. These errors are not automatically correctable, and thus manual correction is required (block 625).

The mark density and location data are checked to ensure that the file begins with a first side of the first sheet (block 641). This error is not automatically correctable, and thus manual correction is required (block 625).

The cart identifier is compared against the cart number that is being expected by the scoring application (block 642). This error is not automatically correctable, and thus manual correction is required (block 625).

The operator identifier field is checked for validity, here, that no nulls are present (block 643). The application 60 pads any nulls with spaces (block 644). If this error is not repaired properly, manual correction is required (block 625).

The file, when created, will have a date/time stamp associated therewith. This date/time stamp is checked for validity (block 645). This error is not automatically correctable, and thus manual correction is required (block 625).

Next the program identifier, order number, cart identifier, form identifier, and block sequence are checked (block 646). These errors are not automatically correctable, and 15 thus manual correction is required (block 625).

A series of counts are then checked: record count, document count, and sheet count (block 647). The application 60 can repair these counts if an error is found. If these errors are not repaired properly, manual correction is required (block 625).

If all checks have been validated and corrected (block 648), the cart is approved for proceeding to storage (block 649), and the associated file is transferred to server 30 (block 650). If any error remains (block 648), the cart fails, and must be returned for manual correction (block 625).

It may be appreciated by one skilled in the art that additional embodiments may be contemplated, including analogous systems and methods for processing questionnaires.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiment thereof, and the advantageous new and useful results obtained thereby, the new and useful constructions, and reasonable mechanical equivalents thereof obvious to those skilled in the art, are set forth in the appended claims.

What is claimed is:

1. A method for improving an accuracy of an electronic record containing data from an answer page of a test booklet comprising the steps of:
(a) receiving a record containing digital image scan data on an answer page;
(b) checking for a plurality of types of errors in the record;
(c) automatically correcting any errors found in a predetermined list of automatically correctable errors; and
(d) flagging the record for manual correction if any of the found errors is not on the predetermined list.

2. The method recited in claim 1, wherein the image scan data comprise a plurality of data related to the answer page from the digital image, the data including metadata.

3. The method recited in claim 2, wherein the record-receiving step comprises retrieving a stored record, further comprising the step, following the error-checking step, of, if an error was detected and corrected, replacing the stored record with the corrected record.

4. The method recited in claim 3, further comprising the steps, following the flagging step, of making a manual correction to the record and replacing the stored record with the corrected record.

5. The method recited in claim 1, wherein the image scan data comprise an infrared reflective image scan.

6. The method recited in claim 1, wherein:
the record further comprises a mark location; and
the error-checking step further comprises checking for an error in the mark.

7. The method recited in claim 1, wherein the record further comprises an image density.

8. The method recited in claim 1, further comprising the step, prior to the automatically correcting step, of comparing each error found in the record against the predetermined list of automatically correctable errors.

9. The method recited in claim 8, wherein the automatically correcting step comprises retrieving and executing a respective error-correction protocol linked to the predetermined list of correctable errors.

10. The method recited in claim 9, further comprising the step, following the executing step, of determining whether the error has been corrected, and, if the error has not been corrected, flagging the record for manual correction.

11. The method recited in claim 1, wherein, if an error is detected, maintaining a log of a type of error for correlation with other record errors.

12. The method recited in claim 11, further comprising the step of periodically reviewing the error log to enable improvement on a source of a persistent error.

13. The method recited in claim 1, further comprising the steps, prior to the record-receiving step, of:
determining whether an answer page contains an answer to an open-ended question;
if the answer page does not contain an answer to an open-ended question, performing only an optical mark recognition scan and storing a record containing data from the optical mark recognition scan;
if the answer page contains an answer to an open-ended question, performing an image scan of the answer page to form the record and proceeding with steps (a)-(d).

14. A software application for improving an accuracy of an electronic record containing data from an answer page of a test booklet comprising:
a code segment for receiving a record containing digital image scan data on an answer page;
a code segment for checking for a plurality of types of errors in the record;
a code segment for automatically correcting any errors found in a predetermined list of automatically correctable errors; and
a code segment for flagging the record for manual correction if any of the found errors is not on the predetermined list.

15. The software application recited in claim 14, further comprising a code segment for comparing each error found in the record against the predetermined list of automatically correctable errors prior to executing the automatically correcting code segment.

16. The software application recited in claim 15, wherein the automatically correcting code segment comprises a code segment for retrieving and executing a respective error-correction protocol linked to the predetermined list of correctable errors.

17. The software application recited in claim 16, wherein the executing code segment comprises a code segment for determining whether the error has been corrected, and, if the error has not been corrected, branching to the flagging code segment.

18. The software application recited in claim 14, further comprising a code segment for, if an error is detected, maintaining a log of a type of error for correlation with other record errors.

19. A system for improving an accuracy of an electronic record containing data from an answer page of a test booklet comprising:
a storage device containing a plurality of records, each record containing digital image scan data on an answer page;
a processor in signal communication with the storage device; and
a software application resident on the processor comprising:
a code segment for requesting and receiving a record from the storage device;
a code segment for checking for a plurality of types of errors in the record;
a code segment for automatically correcting any errors found in a predetermined list of automatically correctable errors; and
a code segment for flagging the record for manual correction if any of the found errors is not on the predetermined list.

20. The system recited in claim 19, wherein the storage device comprises a first database for storing a digitized image of the answer page and a second database for storing metadata related to the image.

21. The system recited in claim 19, further comprising an output device in communication with the processor, and wherein the software application further comprises a code segment for transmitting an indicator relating to the flagged record to the output device.

22. The system recited in claim 19, wherein the storage device further contains the predetermined list of automatically correctable errors and a plurality of error-correction protocols linked to the list of automatically correctable errors, and wherein the code segment for automatically correcting errors comprises a code segment for retrieving a respective error-correction protocol from the storage device and a code segment for executing the protocol.

23. The system recited in claim 22, wherein the code segment for executing the protocol comprises a code segment for determining whether the error has been corrected, and, if the error has not been corrected, flagging the record for manual correction.

24. The system recited in claim 19, wherein the software application further comprises a code segment for, if an error is detected, updating and maintaining a log of a type of error for correlation with other record errors.
